(19) United States
(12) Patent Application Publication
(10) Pub. No.: US 2010/0316906 A1
(43) Pub. Date: Dec. 16, 2010

(54) PRISMATIC CELL AND PACKED BATTERY USING THE SAME

(75) Inventors: Kenji Nansaka, Osaka (JP); Yasuhiro Yamauchi, Sumoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/794,086

(22) Filed: Jun. 4, 2010

(30) Foreign Application Priority Data
Jun. 11, 2009 (JP) 2009-139765

(51) Int. Cl. H01M 2/02

(52) U.S. Cl. 429/181

(57) ABSTRACT

The prismatic cell of the present invention includes a rectangular outer can having a mouth portion at the top, a sealing plate that seals the mouth portion, and a positive terminal and a negative terminal that protrude from the sealing plate in a state of insulation from the sealing plate, the side faces and bottom faces of the rectangular outer can being covered by a bottomed rectangular tubular holder made of rubber. Thereby, it is possible to provide with ease a packed battery in which short-circuiting between the interconnected prismatic cells can be more reliably prevented, and to provide a prismatic cell which is optimal for use in the battery of an electric vehicle (EV), a hybrid electric vehicle (HEV), or the like.

### TECHNICAL FIELD

The present invention relates to a prismatic cell, and a packed battery using the same, that are suitable for use in battery-driven vehicles such as electric vehicles (EVs) or hybrid electric vehicles (HEVs). More particularly, it relates to a packed battery of such prismatic cells, in which short-circuiting between the interconnected prismatic cells can be more reliably prevented.

### BACKGROUND ART

With the rise of the environmental protection movement, emission regulations for carbon dioxide and similar gases have been made more stringent and the automobile industry is vigorously developing EVs and HEVs as well as automobiles using fossil fuels such as gasoline, diesel oil, and natural gas. In addition, development of these EVs and HEVs has been spurred by the steeply soaring prices of fossil fuels over recent years. In the field of batteries for EVs and HEVs, attention has focused on nonaqueous electrolyte secondary batteries, exemplified by lithium ion secondary batteries, which have high energy density compared with other batteries, and the share of these nonaqueous electrolyte secondary batteries in this field has shown large growth.

However, for high-power applications such as EVs and HEVs, use is made of packed batteries, in which multiple cells are connected in series and/or in parallel. Since they are required to provide high output in a restricted space, the packed batteries used as the power sources for EVs and HEVs often employ prismatic cells, which have superior energy density to cylindrical cells.

A packed battery using prismatic cells generally has a structure such as shown in FIG. 6, in which multiple prismatic cells are arranged at equal spacing with spacers interposed and are yoked together (JP-A-2008-78008). The packed battery shown in FIG. 6 is so structured that multiple prismatic cells 61 having external terminals 62 are arrayed in a row and yoked together by yoke members. The yoke members are composed of yoke plates 60A, 60B disposed at the two ends of the row of prismatic cells 61, and clamp beams 63 that are fixed to the yoke plates 60A, 60B by screws 64.

However, with such a packed battery of multiple prismatic cells connected in series and/or in parallel, efficient heat dissipation capability is required because the prismatic cells are closely placed. Particularly with lithium ion secondary batteries, in which thermal runaway is liable to occur due to some cause or other, spacers are employed to keep adjacent prismatic cells thermally separated from each other. Also, when disposed between prismatic cells that use metallic outer cans, such spacers also perform the role of insulating the outer cans from each other.

When multiple prismatic cells are configured as a packed battery, there is risk of short-circuits occurring if the outer cans become electrically joined at places other than the connection portions of the external terminals of adjacent prismatic cells. There is also a problem that the inner surface of an outer cans could become electrically joined to the electrode group, and in such state the outer can could become electrically joined to some item other than the adjacent cell, such as the housing of electrical equipment, so that electrical leakage occurs and the performance of the prismatic cells falls.

Nevertheless, in the related art it has been the practice only to interpose spacers between the prismatic cell surfaces which otherwise might contact, and the other portions of the prismatic cell outer cans have been left exposed. Consequently, there has been risk that, for example, during assembly of a packed battery, tools or parts might be accidentally dropped onto, or inadvertently brought into contact with, the terminals, metal surfaces, or other exposed portions of the outer cans, and such contacting could result in occurrence of electrical leakage and short-circuiting.

Whereas in the case of a cylindrical cell it is relatively simple to sheathe the cell with a thermal contraction tube so as to leave only the electrode terminal portions exposed, it is not easy to sheathe the whole exterior of a prismatic cell so as to leave only the electrode terminals exposed.

JP-A-2008-166191 discloses a battery pack 100 for resolving the foregoing problems, which has multiple battery cells 71 connected in series and/or in parallel. As shown in FIG. 7, this battery pack 100 has multiple battery cells 71 each housed in a rectangular outer can, and multiple insulative and adiabatic spacers 74 that sheathe the exterior of the outer cans except for the electrode terminals 72 of the battery cells 71, each spacer 74 being interposed between a pair of battery cells 71 in such a manner that the outer cans of the battery cells 71 contact its two sides, the electrode terminals 72 being left exposed when the outer cans of the battery cells 71 are sheathed by the spacers 74, and such exposed portions being connected. Thereby, the exteriors of the battery cells 71 are sheathed except for the required parts, and accidental short-circuiting, etc., can be effectively inhibited.

Also, JP-A-2004-47332 discloses a secondary cell having an outer can which has an insulating layer containing oxide membrane formed on its surface and which houses an electrode group. It is held that with such secondary cell, thanks to an insulating layer containing oxide membrane being formed on the surface of the outer can that houses the electrode group, short-circuiting or electrical leakage arising as a result of contacting between the secondary cell and external conductors can be prevented. It is disclosed that thereby, as well as the insulation performance of the secondary battery, its safety and reliability also can be improved.

### SUMMARY

However, even using the methods of JP-A-2008-166191, it has not been possible to completely prevent short-circuiting between adjacent prismatic cells in a packed battery. Also, with the methods of JP-A-2004-47332, a process of forming the insulating layer containing oxide membrane on the outer can surface is needed, resulting in the problems that cost is high and productivity is poor. Also, because the process of forming the insulating layer containing oxide membrane on the outer can surface is carried out before assembly of a packed battery, and because the outer can and the sealing plate are laser-welded together, it is not possible to form the insulating layer as far as the top edges of the outer can side faces. Thus, it has not been possible to reliably prevent short-circuiting between adjacent prismatic cells.

An advantage of some aspects of the present invention is to provide a prismatic cell such that, when used in a plurality for a packed battery, short-circuiting between the interconnected prismatic cells can be more reliably prevented, and a packed battery using the same.

The present inventors discovered, as a result of many and various investigations, that the cause of the short-circuiting between interconnected prismatic cells with JP-A-2008-166191 is water occurring due to condensation. In an environment such as an EV or HEV where a packed battery is deployed as a power source, water is prone to occur due to condensation. Short-circuiting due to direct contacting between prismatic batteries, or via a tool or the like as intermediary, can be prevented if the prismatic cells are sheathed by being sandwiched between two insulative and adiabatic resin spacers, one on each of their two sides, with adjacent spacers being fitted together, as in JP-A-2008-166191. But it has been found that if water occurring due to condensation is present in proximity to a packed battery, there is a possibility that the water will enter inside the spacer fitting portions and that via such water, short-circuiting will occur in the interconnected prismatic cells. For instance, the following closed circuit may occur: (cell interior) cell positive electrode/electrolyte/can→(cell exterior) can/condensation water/metallic floor/condensation water/can→(cell interior) can/electrolyte/cell negative electrode→cell negative electrode/negative electrode terminal/busbar/positive electrode terminal/cell positive electrode; resulting in a short-circuited state. Such a short-circuit is not limited only to adjacent prismatic cells, but may also occur in prismatic cells that are disposed apart from each other by other prismatic cells interposed between them. Where a short-circuited state occurs between such separated prismatic cells, their potential will rise by an amount equal to the voltage of the prismatic cells that are present between them, posing risk of rapid electric corrosion of the cans.

According to an aspect of the invention, a prismatic cell includes a rectangular outer can having a mouth portion at the top, a sealing plate that seals the mouth portion, and a positive terminal and a negative terminal that protrude from the sealing plate in a state of insulation from the sealing plate, the side faces and bottom faces of the rectangular outer can being covered by a bottomed rectangular tubular holder made of rubber.

With such aspect of the invention, thanks to the side faces and bottom face of the rectangular outer can being covered by a bottomed prismatic tubular holder made of rubber, water will not enter the side faces and bottom face of the prismatic cell through the spacer fitting portions in cases where the prismatic cell is covered by multiple spacers fitted together. Thus, short-circuiting of the interconnected prismatic cells can be more reliably prevented. Further, since the holder that covers the prismatic cell is a bottomed rectangular tubular one, manufacture will be a simple matter of inserting the prismatic cell into the rubber holder after the prismatic cell has been assembled.

Also, since the holder is made of rubber, the battery will be able to dissipate heat efficiently even when it heats up due to charge/discharge, etc. Further, when the prismatic cell is used in a packed battery, it will be able to alleviate impacts or vibration, so that adverse effects on the battery can be lessened. Also, occurrence of the prismatic cells coming out of position due to impacts or vibration can be lessened.

In such prismatic cell of the invention, it is preferable that the top edge portion of the sidewalls of the rubber holder protrude above the top edge portion of the sidewalls of the rectangular outer can.

With the top edge portion of the sidewalls of the rubber holder protruding above the top edge portion of the sidewalls of the rectangular outer can, short-circuiting of the sealing plates—which are not covered by the rubber holders—of adjacent prismatic cells due to interposition between them of a dropped tool or other object will be prevented. Thus, short-circuiting of adjacent prismatic cells can be more reliably prevented.

For the rubber holder, silicone rubber, ethylene propylene diene terpolymer (EPDM), butyl rubber, chloroprene rubber, fluoro-rubber, or the like, may be used. Of these, silicone rubber or EPDM will be preferable, since they have superior insulating properties, resistance to heat and cold, and weatherability, and also have a high degree of flexibility, which means that they can readily be fitted onto a prismatic cell.

In such prismatic cell of the invention, it is preferable that the mouth portion of the rectangular outer can be sealed by laser-welding a sealing plate over the mouth portion.

With such structure, a prismatic cell with higher sealing reliability is obtained, because the outer can and sealing plate are welded and sealed together by laser-welding.

A plurality of such prismatic cells may be connected to form a packed battery, with spacings provided between each pair of rubber holders covering the opposed side faces of adjacent prismatic cell rectangular outer cans.

If the prismatic cells were disposed so that the rubber holders covering them were closely in contact with one another, it would be difficult to dissipate the heat generated by the battery. But with a packed battery having a structure such as that described above, in which multiple prismatic cells are connected together with a spacing provided between the pairs of rubber holders covering each of adjacent prismatic cells, the gaps between the pairs of rubber holders can be utilized for cooling the prismatic cells. Possible cooling methods include delivering a cooling medium through the gaps between the prismatic cells, or inserting a cooling device. Alternatively, the spacers interposed between the pairs of rubber holders each covering an individual prismatic cell might themselves be given cooling or heat dissipating capabilities.

Thus, the present invention makes it possible to provide with ease a packed battery in which short-circuiting between the interconnected prismatic cells can be more reliably prevented, and to provide a prismatic cell which is optimal for use in the battery of an electric vehicle (EV), a hybrid electric vehicle (HEV), or the like.

### BRIEF DESCRIPTION OF THE DRAWINGS

The invention will be described with reference to the accompanying drawings, in which the same numbers refer to the same elements throughout.

FIG. 1A is a transparent front view of the outer can of a prismatic cell that is common to a Working Example and a Comparative Example, and FIG. 1B is a cross-sectional view through IB-IB in FIG. 1A.

FIG. 2A illustrates how a prismatic cell is inserted into a bottomed rectangular tubular holder made of rubber, and FIG. 2B illustrates the prismatic cell in the inserted state with the side faces and bottom face of the rectangular outer can covered by the bottomed rectangular tubular holder made of rubber.

FIG. 3 illustrates how the top edge portion of the sidewalls of the rubber holder protrudes above the top edge portion of the sidewalls of the rectangular outer can.

FIG. 4A is a side view of a packed battery in the Working Example of the invention, and FIG. 4B is a top view of the packed battery in the Working Example.

FIG. 5 illustrates methods for measuring electrical leakage resistance.

FIG. 6 illustrates a structure of the related art, whereby multiple prismatic cells are arranged at an equal spacing with spacers interposed and are yoked together.

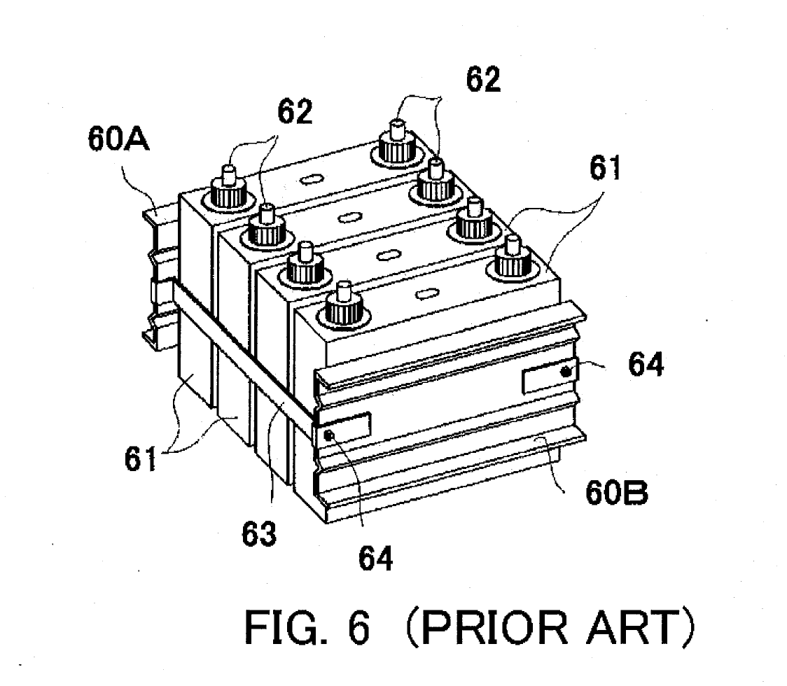

FIG. 7 illustrates a packed battery of the related art, composed of prismatic cells whose exteriors are covered by fitting multiple spacers together.

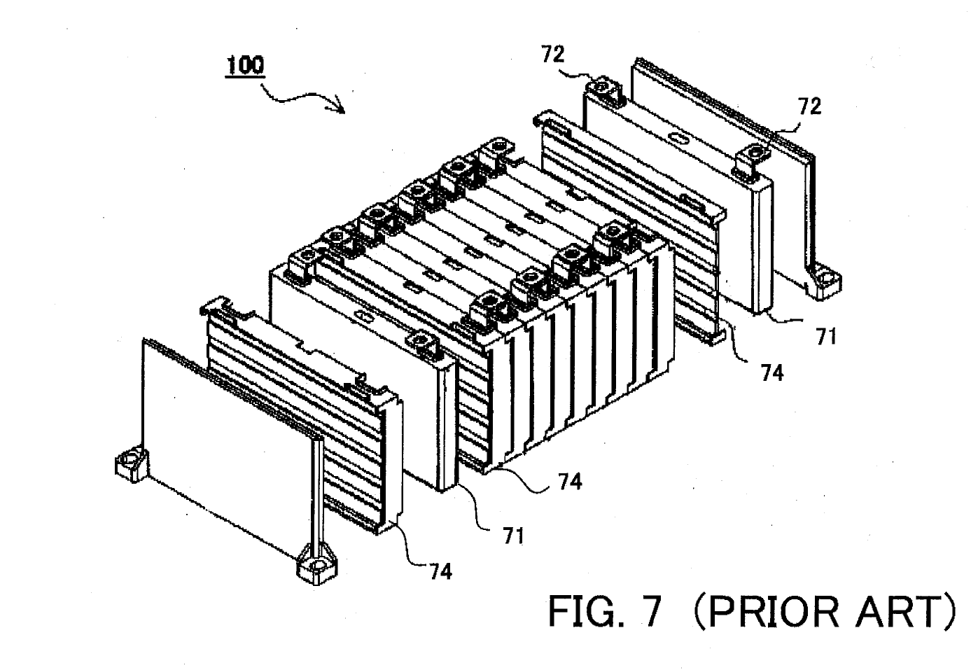

### DESCRIPTION OF EXEMPLARY EMBODIMENT

An exemplary embodiment of the invention will now be described in detail with reference to the drawings attached. It should be understood however that this embodiment is intended by way of an illustrative example of a prismatic nonaqueous electrolyte secondary battery that carries out the technical concepts of the invention, and is not intended by way of limiting the invention to this particular prismatic nonaqueous electrolyte secondary battery. The invention could equally well be applied to yield many variants of the embodiment without departing from the technical concepts set forth in the claims.

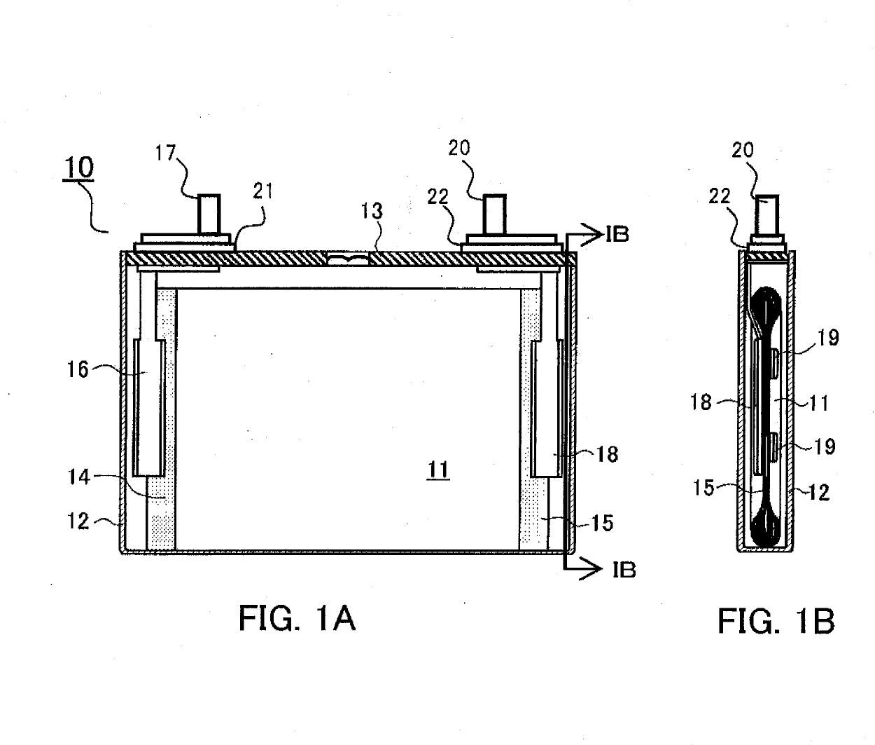

First, referring to FIG. 1, a prismatic nonaqueous electrolyte secondary cell will be described, as an instance of a prismatic cell that is common to the working example and the comparative example.

In this prismatic nonaqueous electrolyte secondary cell 10, a flat wound electrode group 11, constituted of positive electrode plates (omitted from the figure) and negative electrode plates (omitted from the figure) wound with separators (omitted from the figure) interposed, is housed inside a rectangular outer can 12, and the outer can 12 is sealed by a sealing plate 13.

The flat wound electrode group 11 has, at one end in the winding axis direction, a positive substrate exposed portion 14 where no positive electrode active material layer is formed, and at the other end, a negative substrate exposed portion 15 where no negative electrode active material layer is formed. The positive substrate exposed portion 14 is connected to the positive electrode terminal 17 via the positive electrode collector 16, and the negative substrate exposed portion 15 is connected to the negative electrode terminal 20 via the negative electrode collector 18. Also, a positive electrode collector receiving member (omitted from the figure) is connected, via the positive substrate exposed portion 14, to the portion opposed to the positive electrode collector 16, and a negative electrode collector receiving member 19 is connected, via the negative substrate exposed portion 15, to the portion opposed to the negative electrode collector 18. The positive electrode terminal 17 and the negative electrode terminal 20 are connected to the sealing plate 13 via insulating materials 21 and 22, respectively. The positive electrode terminal 17 and the negative electrode terminal 20 have a planar portion disposed parallel to the sealing plate 13 and a bolt portion that is connected to such planar portion, and are connected to an adjacent prismatic cell by means of such bolt portion.

To manufacture this prismatic nonaqueous electrolyte secondary cell 10, the flat wound electrode array 11 is inserted inside the outer can 12, then the sealing plate 13 is laser-welded to the mouth portion of the outer can 12, after which nonaqueous electrolyte is poured in through an electrolyte pour hole (omitted from the figure) and the electrolyte pour hole is sealed up.

The methods for manufacturing the prismatic nonaqueous electrolyte secondary cell 10 that is common to the Working Example and the Comparative Example will now be described in detail.

### Fabrication of Negative Electrode Plate

Natural graphite serving as the negative electrode active material, and carboxymethyl cellulose (CMC) and styrene-butadiene rubber latex (SBR) serving as binding agents, are mixed in the proportions 98%, 1% and 1% by mass. Then water is added and the mixture is stirred to produce negative electrode active material mixture slurry. Next, the negative electrode active material mixture slurry made in the foregoing manner is applied evenly over both surfaces of a strip of copper foil (10 μm thick) serving as the negative electrode substrate, to form a negative electrode active material layer thereon, in such a manner as to leave at the edge of the electrode a portion where the negative electrode substrate remains exposed. Then the negative electrode active material mixture layer is dried to remove the water that served as solvent in the slurry making process. After that, the substrate with the layer thus formed thereon is rolled in a roll press into a negative electrode plate of packing density 1.1 g/cc.

### Fabrication of Positive Electrode Plate

LiCoO₂ serving as the positive electrode active material, carbon material serving as the conducting material, and polyvinylidene-fluoride (PVdF) serving as the binding agent, are mixed in the proportions 88%, 9% and 3% by mass. Then N-methyl-pyrrolidone (NMP) is added to the resulting mixture and stirred in to produce positive electrode active material mixture slurry. Next, the positive electrode active material mixture slurry made in the foregoing manner is applied evenly over both surfaces of a strip of aluminum foil (15 μm thick) serving as the positive electrode substrate, to form a negative electrode active material layer thereon, in such a manner as to leave at the edge of the electrode a portion where the positive electrode substrate remains exposed. Then the positive electrode active material mixture layer is dried to remove the NMP that served as solvent in the slurry making process. After that, the substrate with the layer thus formed thereon is rolled in a roll press into a positive electrode plate of packing density 2.6 g/cc, which is then cut to particular dimensions.

### Preparation of Nonaqueous Electrolyte

To prepare the nonaqueous electrolyte, first ethylene carbonate (EC), a ring carbonate, and ethylmethyl carbonate (EMC), a chain carbonate, are mixed in the proportion 3:7 by volume to form a mixed solvent, into which and 1 mole/L of lithium hexafluorophosphate (LiPF₆) is dissolved. Then vinylene carbonate (VC) in the quantity 1% by mass is added to the mixed solution thus obtained.

### Fabrication of Nonaqueous Electrolyte Secondary Cell

Positive electrode plates and negative electrode plates prepared as described above are stacked over each other with separators constituted of a microporous membrane having a trilaminar structure of PP+PE+PP (PP being polypropylene and PE being polyethylene) interposed, and are wound into a spiral form. Then the outmost peripheries are sealed with tape, to produce a cylindrical wound electrode group. After that, the cylindrical wound electrode group is pressed to produce a flat wound electrode group 11.

At one end of the wound electrode group 11 fabricated as described above, the positive substrate exposed portions 14 of the positive electrode plates protrude outward from one edge of the separators, and at the other end, the negative substrate exposed portions 15 of the negative electrode plates protrude outward from the other edge of the separators.

Next, the collectors 16, 18 and the collector receiving parts 19 are installed to the positive substrate exposed portions 14 and negative substrate exposed portions 15, respectively, of the electrode group 11, and the collectors 16, 18 are connected to the terminals 17, 20, respectively, that have been installed to the sealing plate 13 with the insulating materials 21, 22 interposed. The terminals 17, 20, have a planar portion disposed parallel to the sealing plate 13 and a bolt portion connected to the planar portion. Next, the flat wound electrode group 11 is inserted into the rectangular outer can 12 in such a way that the winding axis is parallel with the mouth portion of the outer can 12. The outer can used in the Examples described hereafter was a 0.5 mm thick aluminum outer can 12. The mouth portion of the outer can 12 is then sealed by laser-welding the sealing plate 13 thereonto, and the required amount of nonaqueous electrolyte is poured in through the electrolyte pour hole (omitted from the figure) provided in the sealing plate 13. Then the electrolyte pour hole is sealed up, completing fabrication of the prismatic nonaqueous electrolyte secondary cell 10 which is common to the Working Example and the Comparative Example.

### Working Example

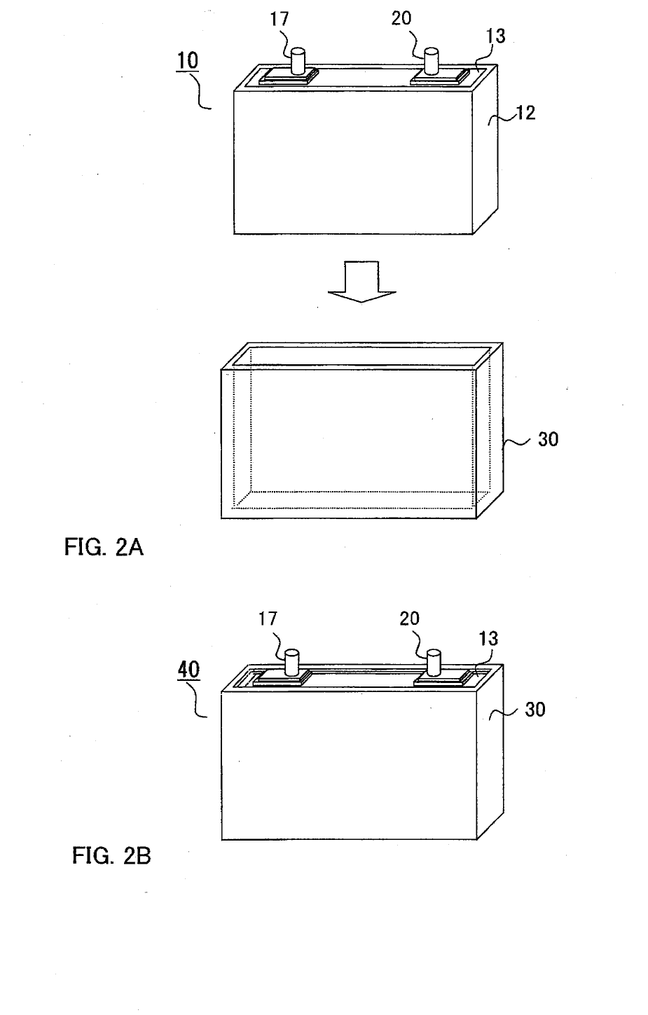

The prismatic nonaqueous electrolyte secondary cell 10 fabricated in the foregoing manner was inserted into a bottomed prismatic tubular rubber holder 30, in which the bottom was formed as one piece with the sidewalls, as shown in FIG. 2A. The rubber holder 30 used was of silicone rubber (hardness (JIS K6253): Hs 35, tensile strength: 9.0 MPa, elongation at break (JIS K6251): 610%). Also, the sidewalls of the rubber holder 30 used were 0.3 mm thick. In the prismatic cell 40 thus obtained, the bottom and sidewalls of the prismatic nonaqueous electrolyte secondary cell 10 were covered by the bottom and sidewalls of the bottomed prismatic tubular rubber holder 30, each closely contacting with the other, as shown in FIG. 2B.

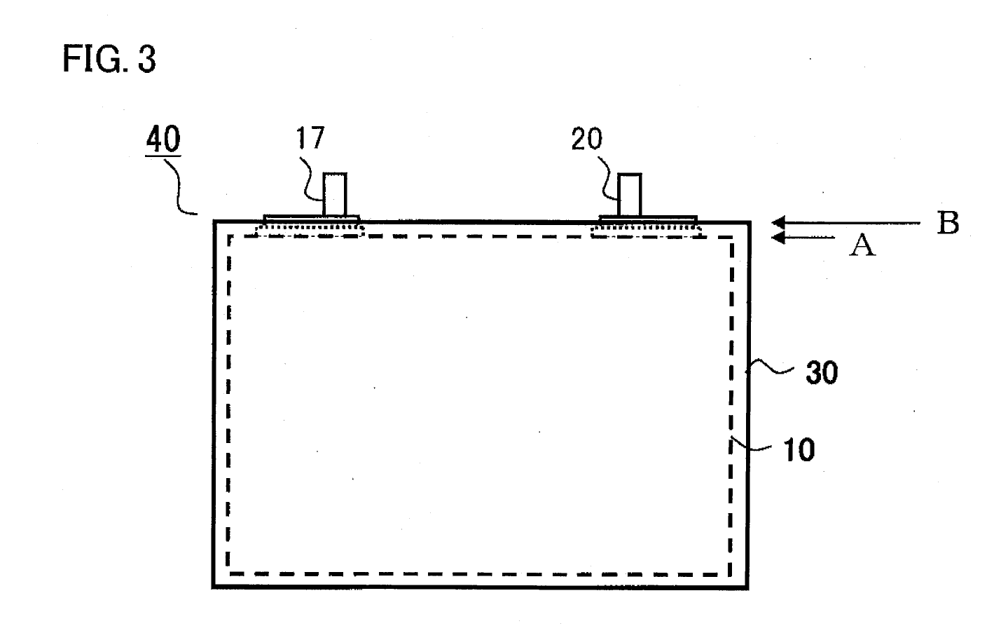

Also, FIG. 3 is a front view, seen through the rubber holder 30, of the prismatic nonaqueous electrolyte secondary cell 10 when covered by the rubber holder 30. “A” in this figure indicates the top edge of the sidewalls of the rectangular outer can 12, and “B” indicates the top edge of the sidewalls of the bottomed prismatic tubular rubber holder 30. As FIG. 3 shows, the structure was such that the top edge B of the sidewalls of the bottomed prismatic tubular rubber holder 30 projects further upward than the top edge (A) of the sidewalls of the rectangular outer can 12.

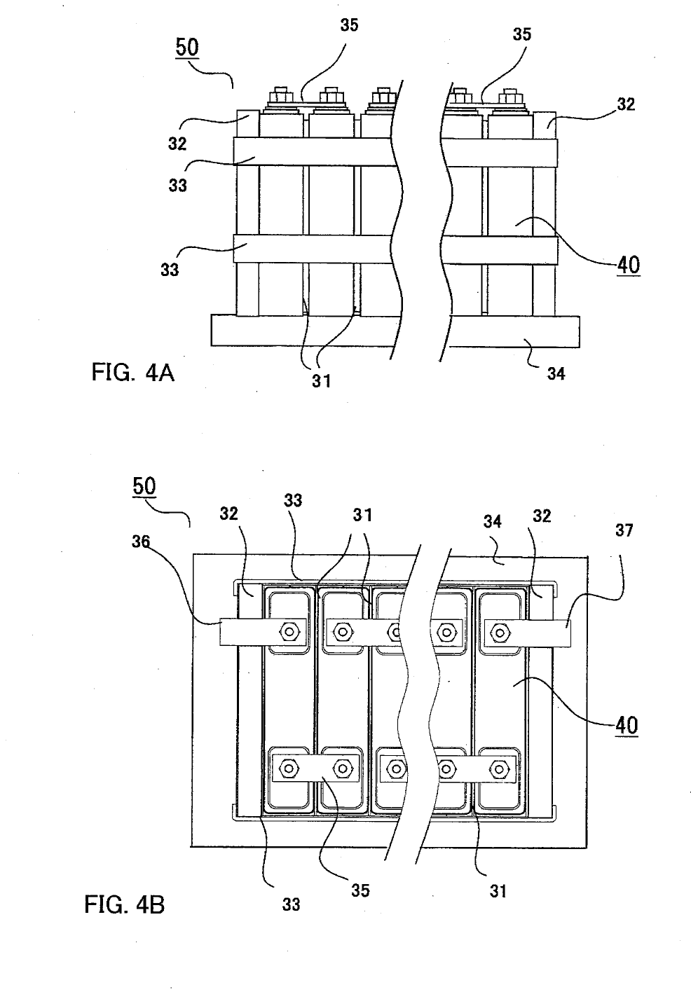

Using prismatic cells 40 covered by rubber holders 30 obtained in the foregoing manner (termed simply “prismatic cells 40” below), the packed battery 50 shown in FIG. 4 was then fabricated. FIG. 4A is a view of the packed battery 50 seen from above, and FIG. 4B is a view of the packed battery 50 seen from one side.

The method for manufacturing the packed battery 50 will now be described. 20 prismatic cells 40 were disposed so that their side faces of the outer can 12 with the larger area were opposed and their positive electrode terminals 17 and negative electrode terminals 20 were positioned alternately at one end of the packed battery 50. An even spacing between the rubber holders 30 each covering an adjacent prismatic cell 40 was secured by interposing spacers 31 (0.5 mm thick) made of nylon 66 between the prismatic cells 40.

Then the prismatic cells 40 thus arranged were integrally coupled together by placing resin plastic end plates 32 in contact with the outer surfaces located at the two ends of the row of prismatic cells 40 and yoking the two end plates 32 with steel binding bars 33. The end plates 32 were then fixed, by screwing, to a metallic base 34 constituting the chassis for the packed battery 50.

After that, the bolt portions of the positive electrode terminals 17 and of the negative electrode terminals 20 of each adjacent pair of prismatic cells 40 were connected by means of busbars 35. Also, an overall positive electrode terminal 36 was connected to the positive electrode terminal 17 of the prismatic cell 40 located at one of the two ends of the packed battery, and an overall negative electrode terminal 37 to the negative electrode terminal 20 of the prismatic cell 40 located at the other end.

### Comparative Example

Instead of covering with a rubber holder the surfaces of the prismatic nonaqueous electrolyte secondary cell 10 fabricated in the foregoing manner, the side faces and bottom face—a total of five faces—of the outer can 12 of the prismatic nonaqueous electrolyte secondary cell 10 were covered by affixing insulating tape (made of polypropylene, 100 μm thick) to each face. The five pieces of insulating tape that were used each had an area larger than that of the face of the outer can 12 to which it was affixed, and were affixed to the side faces and bottom face of the outer can 12 in such a manner that the adjoining edges of the pieces of insulating tape overlapped. Using such prismatic cells, the packed battery of the Comparative Example was then fabricated with the same method as for the Working Example.

The packed batteries fabricated in the Working Example and the Comparative Example were charged to a 10% state of charge (SOC), then underwent a composite test in which, at low temperature (−20° C.), they were subjected to a vibration test, followed by a watertightness test, then were left for 30 minutes. After that, their electrical leakage resistance was measured. These tests were conducted on two samples each from the packed batteries of the Working Example and of the Comparative Example. The details of the tests were as follows.

### Vibration Test

Each sample was subjected to vibration of 27.8 m/s² acceleration in three axial directions for eight hours.

### Watertightness Test

50 cc of tap water was applied with a dropper evenly over one side face of the packed battery, so as to simulate condensation.

### Measurement of Electrical Leakage Resistance

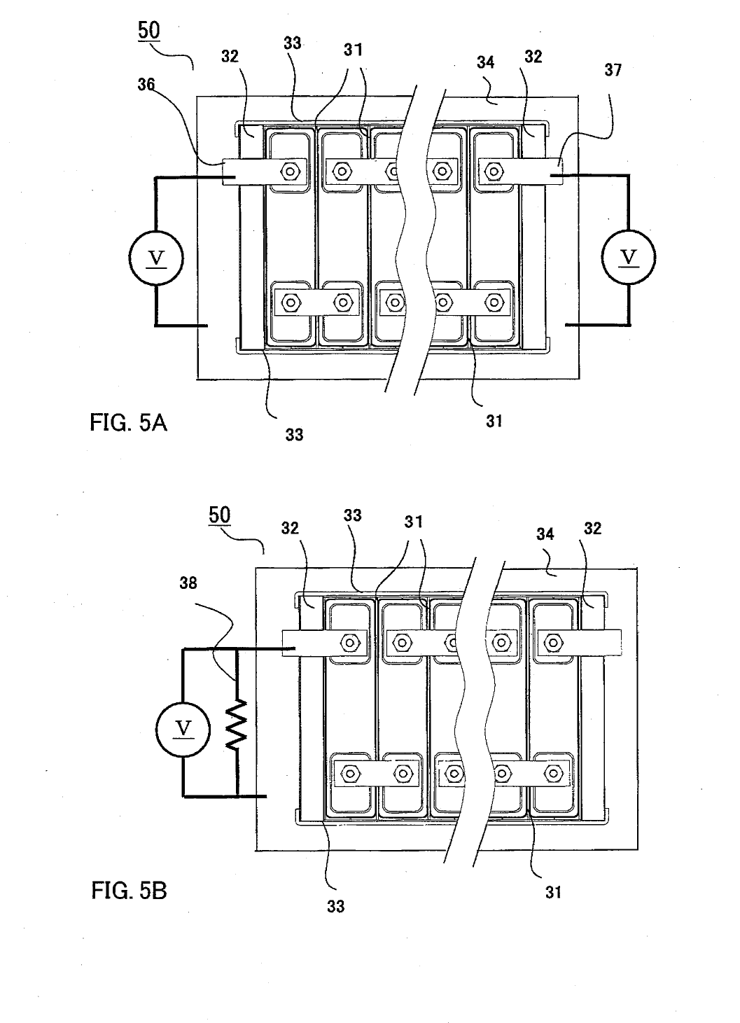

The voltages between the overall positive electrode terminal 36 and metallic base 34 of the packed battery, and between the overall negative electrode terminal 37 and metallic base 34 of the packed battery, were measured as shown in FIG. 5A. Then, designating the higher of such measured voltages as V1, the voltage between the overall electrode terminal designated as V1 and the metallic base 34 of the packed battery was measured with a 100 kΩ resistance wire 38 attached therebetween. The value so measured was designated as V2, and used to calculate the electrical leakage resistance by means of the following equation:

Electrical leakage resistance=((V1−V2)/V2)×100 kΩ

The results were as follows. The electrical leakage resistances of the two samples in the Comparative Example were over 5 MΩ, and 3.2 MΩ, respectively, which means that electrical leakage occurred in one out of two samples. By contrast, both samples in the Working Example, which was carried out according to the present invention, had electrical leakage resistance of over 5 MΩ, which means that no electrical leakage was found in either sample.

On dismantling and examining the Comparative Example sample that had been found to have electrical leakage, it was found that water had entered through the overlap portions of the insulating tape, and that consequently there was continuity with the outer can via the metallic base. These results showed that the Working Example of the invention has advantages for prevention of short-circuiting due to condensation water.

Thus, the present invention is able to provide with ease a packed battery in which short-circuiting of the interconnected prismatic cells can be more reliably prevented, and to provide a prismatic cell optimal for use in the battery of an electric vehicle (EV), hybrid electric vehicle (HEV), or the like.

Although in the foregoing Working Example an instance was described in which the present invention was applied to a nonaqueous electrolyte secondary cell, the prismatic cell of the invention is not limited to a nonaqueous electrolyte secondary cell, and could also be applied to an alkaline storage cell such as a nickel-hydrogen storage cell or nickel-cadmium storage cell, or to a storage cell of other type, provided that such cell is a prismatic cell with an electrode group housed inside a rectangular metallic outer can. Further, although in the foregoing Working Example the use of a flat electrode group produced by flattening a wound electrode group was described, it is evident that the invention can be applied to any electrode group with a flat shape, such as, for instance, a flat electrode group composed of flat-plate positive electrode plates and negative electrode plates stacked with separators interposed.

What is claimed is:

1. A prismatic cell comprising:
a rectangular outer can having a mouth portion at the top;
a sealing plate that seals the mouth portion; and
a positive terminal and a negative terminal that protrude from the sealing plate in a state of insulation from the sealing plate,
the side faces and bottom faces of the rectangular outer can being covered by a bottomed rectangular tubular holder made of rubber.

2. The prismatic cell according to claim 1, wherein the top edge of the sidewalls of the rubber holder protrudes above the top edge portion of the sidewalls of the rectangular outer can.

3. The prismatic cell according to claim 1, wherein the rubber holder is constituted of silicone rubber or of ethylene propylene diene terpolymer.

4. The prismatic cell according to claim 1, wherein the mouth portion of the rectangular outer can is sealed by laser-welding a sealing plate over the mouth portion.

5. A packed battery comprising:
a prismatic cell including:
a rectangular outer can having a mouth portion at the top;
a sealing plate that seals the mouth portion, the side faces and bottom faces of the rectangular outer can being covered by a bottomed rectangular tubular holder made of rubber; and
a positive terminal and a negative terminal that protrude from the sealing plate in a state of insulation from the sealing plate,
more than one such prismatic cells being connected together, and spacings being provided between each pair of rubber holders covering the opposed side faces of adjacent prismatic cell rectangular outer cans.

6. The packed battery according to claim 5, wherein the top edge of the sidewalls of the rubber holders protrudes above the top edge portions of the sidewalls of the rectangular outer cans.

7. The packed battery according to claim 5, wherein the rubber holders are constituted of silicone rubber or of ethylene propylene diene terpolymer.

8. The packed battery according to claim 5, wherein mouth portions of the rectangular outer cans are sealed by laser-welding a sealing plate over the mouth portion.
